(19) United States
(12) Patent Application Publication
(10) Pub. No.: US 2008/0285979 A1
(43) Pub. Date: Nov. 20, 2008

(54) HIGH-SPEED OPTICAL COMMUNICATION

(75) Inventors: Shuji SUZUKI, Tokyo (JP); Ryuhei FUJIWARA, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 11/950,524

(22) Filed: Dec. 5, 2007

(30) Foreign Application Priority Data
Dec. 14, 2006 (JP) 2006-337151

(51) Int. Cl. H04B 10/00; H04B 10/04; H04B 10/06

(52) U.S. Cl. 398/140; 398/182; 398/202

(57) ABSTRACT

A high-speed optical communication system for transmitting and receiving an optical signal is disclosed. A contents receiver transmits previously given unique identification information by using a light less intensive than the intensity level of a pre-given threshold. When a contents transmitter receives the identification information transmitted from the contents receiver, it transmits contents data to the receiver by using a laser.

This application is based upon and claims the benefit of priority from Japanese Patent Application No. 2006-337151 filed on Dec. 14, 2006, the content of which is incorporated by reference.

### BACKGROUND OF THE INVENTION

1. Field of the Invention

The present invention relates to an optical communication system that performs optical communication by transmitting and receiving optical signals, a contents transmitter, a contents receiver and a method for the same.

2. Description of the Related Art

When a person wants to listen to a desired piece of music, or view a desired movie, drama, etc., which is not aired on TV, the person acquires a CD containing that piece of music, or a video tape or a DVD containing that movie, drama, etc. to enjoy that music, movie, drama, etc., by playing the CD, video tape, or DVD.

The acquisition methods include purchase and rental.

With the development of information communication networks such as the Internet, it has become popular to use various methods for downloading a desired piece of music, movie, drama, etc. (hereinafter, referred to as content) to such a communication device as a personal computer that is connected via communication means with the information communication network.

Recently, it has become been more and more popular to make use of an ubiquitous environment in which the information communication network can be accessed anytime from anywhere. Techniques for downloading contents by making use of the ubiquitous environment have been developed. For example, the contents are distributed from a server that stores various types of contents on KIOSK terminals located at convenience stores and stations. Then, from an optical transmitter provided for the KIOSK terminal, the contents are transmitted by visible light emitted from an LED or the like. A technique for downloading the contents to the mobile terminal held over the optical transmitter in the above-described manner is disclosed in the document 1 “Visible light Communications Consortium Industry/university cooperation Introduction of mobile/optical tag WG activities http:www.vlcc.net/working/keitai_wg.html”. Here, the use of optical communication contributes to shortening the downloading time.

It takes a long time to download a large amount of content. That downloading time needs to be much shorter than the time for downloading the contents by visible light. For that purpose, the data communication rate needs to be much faster (Gb/s transmission).

One way to realize Gb/s transmission is by considering the use of a technique that employs a reliable laser and by making efficient usage of light. Here safety measures are needed to prevent laser light that is radiated from striking the eyes of people.

For that purpose, a radiant power of the laser needs to be significantly lower or a conventional miniature light source needs to be larger. As a method for enlarging the light source to a safe level for human eyes, while keeping the radiant power, a technique of using an eye-safe optical system using diffused reflection or an optical system for performing highly efficient beam transmission that uses uniform radiation distribution, which enables in speeding up the communication is disclosed in the Document 2 “Infrared Communication Systems Association TOPICS-04002 Optical wireless communication from a viewpoint of optical/optical propagation http://www.icsa.gr.jp/topics/2004/index_{—}04002.html”. That requires a system for compensating influences on radiated light in order to optically manipulate the radiated light.

The technique described in the Document 2, however, has a problem in that it needs an optically complicated system.

### SUMMARY OF THE INVENTION

Objects of the present invention are to provide an optical communication system, a contents transmitter, a contents receiver and a method for the same, which enable fast downloading of contents by using laser light in a safe and simple manner.

In order to achieve the abovementioned objects, the present invention includes:

a contents transmitter for transmitting contents data by using a laser and a contents receiver for receiving contents data transmitted from the contents transmitter;

wherein the contents receiver transmits pre-given unique identification information by using a light less intensive than the intensity level of a pre-given threshold; and

the contents transmitter transmits the contents data to the contents receiver by using the laser, when it receives the identification information transmitted from the contents receiver via laser light.

In the present invention that has the above-described configuration, pre-given unique identification information is transmitted from the contents receiver by using a light less intensive than the intensity level of a pre-given threshold, and the contents transmitter transmits contents data to the contents receiver by using a laser according to the received identification information, when it receives the identification information.

Thus, if the contents receiver is not identified by the contents transmitter, the present invention can prevent the transmission of contents from the contents transmitter via laser light.

That enables fast downloading of contents in a safe and simple manner by using a laser.

The above and other objects, features, and advantages of the present invention will become apparent from the following description with reference to the accompanying drawings which illustrate an example of the present invention.

### BRIEF DESCRIPTION OF THE DRAWINGS

FIG. 1 is a diagram illustrating a first exemplary embodiment of an optical communication system according to the present invention;

FIG. 2 is a sequence diagram for illustrating an example of an optical communication method in the optical communication system shown in FIG. 1;

FIG. 3 is a sequence diagram for illustrating another example of the optical communication method in the optical communication system shown in FIG. 1;

FIG. 4 is a diagram showing a second exemplary embodiment of the optical communication system according to the present invention;

FIG. 5 is a sequence diagram for illustrating an example of an optical communication method in the optical communication system shown in FIG. 4;

FIG. 6 is a sequence diagram for illustrating another example of the optical communication method in the optical communication system shown in FIG. 4;

FIG. 7 is a diagram illustrating a third exemplary embodiment of the optical communication system according to the present invention;

FIG. 8 is a sequence diagram for illustrating an example of an optical communication method in the optical communication system shown in FIG. 7;

FIG. 9 is a diagram illustrating a fourth exemplary embodiment of the optical communication system according to the present invention;

FIG. 10 is a sequence diagram for illustrating an example of an optical communication method in the optical communication system shown in FIG. 9;

FIG. 11 is a diagram showing a case where a low-speed light and a laser are transmitted and received between the IC card and the data-writing device shown in FIG. 1;

FIG. 12 is a diagram showing a case where a low-speed light and a laser are transmitted and received between the IC card shown in FIG. 1 and the data-writing device shown in FIG. 1 when the IC card is tilted over the data-writing device with the back of the IC card facing the data-writing device;

FIG. 13 is a diagram showing a case where a low-speed light and a laser are transmitted and received between the IC card and the data-writing device shown in FIG. 4;

FIG. 14 is a diagram showing a case where a low-speed light and a laser are transmitted and received between the IC card shown in FIG. 4 and the data-writing device shown in FIG. 4 when the IC card is tilted over the data-writing device with the back of the IC card facing the data-writing device;

FIG. 15 is a diagram showing an example of an arrangement of a low-speed optical transmitting part and a high-speed optical receiving part on the back of the IC card shown in FIG. 1;

FIG. 16 is a diagram showing an example of a surface of the IC card shown in FIG. 1, on which the orientation of the card to be held over the data-writing device is given, and the top of the data-writing device;

FIG. 17 is a diagram showing another example of an arrangement of low-speed optical transmitting parts and a high-speed optical receiving part on the back of the IC card shown in FIG. 1;

FIG. 18 is a diagram showing an example of the first exemplary embodiment of the optical communication system shown in FIG. 1;

FIG. 19 is a diagram showing another example of the first exemplary embodiment of the optical communication system shown in FIG. 1;

FIG. 20 is a diagram showing a fifth exemplary embodiment of the optical communication system according to the present invention;

FIG. 21 is a diagram showing an example of an arrangement of light exchanging groups on the data-writing device shown in FIG. 20; and

FIG. 22 is a diagram showing another example of an arrangement of light exchanging groups on the data-writing device shown in FIG. 20.

### EXEMPLARY EMBODIMENT

### First Exemplary Embodiment

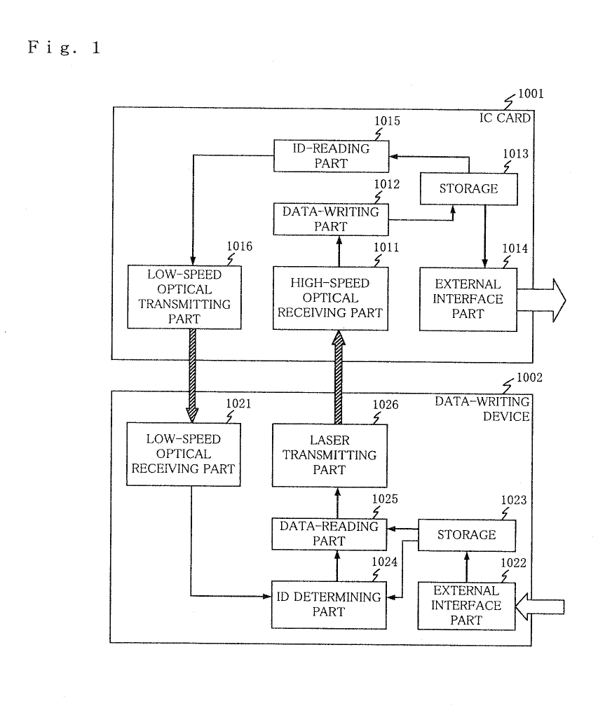

FIG. 1 shows a first exemplary embodiment of an optical communication system with IC card 1001 and data-writing device 1002.

IC card 1001 is a contents receiver carried by a user, which can be tangible electronic equipment such as a mobile terminal. Data-writing device 1002 is a contents transmitter for transmitting contents data to IC card 1001 via laser light.

IC card 1001 includes high-speed optical receiving part 1011, data-writing part 1012, storage 1013, external interface part 1014, ID-reading part 1015, and low-speed optical transmitting part 1016.

High-speed optical receiving part 1011 receives a laser light, that is high-speed light, transmitted from data-writing device 1002. Data-writing part 1012 writes contents data received by high-speed optical receiving part 1011 into storage 1013. Storage 1013 stores identification information such as a unique ID pre-given for IC card 1001 and the contents written by data-writing part 1012. External interface part 1014 transmits the contents data stored in storage 1013 to an external device (not shown). ID-reading part 1015 reads an ID unique to an IC card, which has been stored in storage 1013. Low-speed optical transmitting part 1016 is a position information transmitting part that transmits the ID read out from storage 1013 by ID-reading part 1015 to data-writing device 1002 on low-speed lights. The high-speed light is a light more intensive than the intensity level of a pre-given threshold and is the light for transmit the contents data. The low-speed light is a light less intensive than the intensity level of a pre-given threshold. Here, low-speed optical transmitting part 1016 is an LED.

Data-writing device 1002 includes low-speed optical receiving part 1021; external interface part 1022, storage 1023, ID determining part 1024, data-reading part 1025, and laser transmitting part 1026.

Low-speed optical receiving part 1021 is a position information receiving part that receives a low-speed light transmitted from low-speed optical transmitting part 1016 of IC card 1001. External interface part 1022 receives contents data from an external device (not shown) and writes the received contents data into storage 1023. Storage 1023 stores the ID of IC card 1001 that is accessible to the system, and the contents data written by external interface part 1022. ID determining part 1024 recognizes the ID from the low-speed light received by low-speed optical receiving part 1021. Then, ID determining part 1024 determines whether the recognized ID is in user IDs which have been stored in storage 1023 or not. If it determines that the recognized ID is in the user IDs which have been stored in storage 1023, it directs data-reading part 1025 to read out the contents data. When data-reading part 1025 is directed to read out the contents data by ID determining part 1024, it reads out the contents data from storage 1023. Laser transmitting part 1026 is a high-speed optical transmitting part that transmits the contents data read out by data-reading part 1025 out from storage 1023 to IC card 1001 via a laser.

The exemplary embodiment shown in FIG. 1 only shows components relating to the present invention.

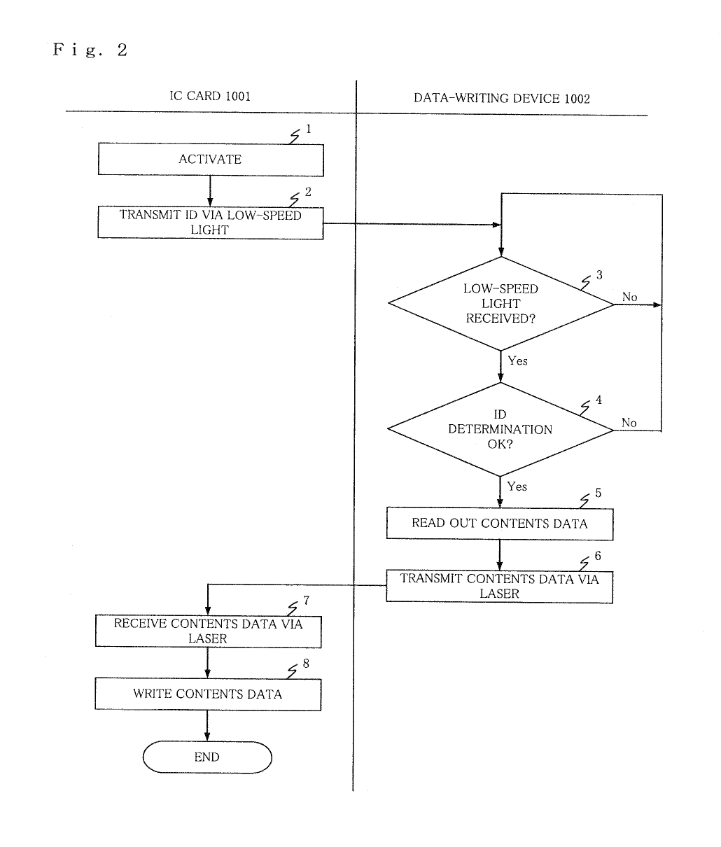

An optical communication method in the optical communication system shown in FIG. 1 will be described with reference to FIG. 2.

A radio wave for supplying power from data-writing device 1002 to IC card 1001 is always radiated. The method for radiating the radio wave is a typical one, thus, the method's detailed description will be omitted here.

When IC card 1001 approaches data-writing device 1002 and is powered and activated at step 1, an ID unique to IC card 1001 that has been stored in storage 1013 is read by ID reading part 1015. The read out ID is transmitted from low-speed optical transmitting part 1016 to data-writing device 1002 via low-speed light at step 2.

On the other hand, it is always determined whether a low-speed light has been received by low-speed optical receiving part 1021 of data-writing device 1002 or not at step 3. If it is determined that the low-speed light transmitted from low-speed optical transmitting part 1016 has been received, the ID carried via the received low-speed light is recognized at ID determining part 1024, and whether the recognized ID is in the user IDs which have been stored in storage 1023 or not is determined at step 4. That is, IC card 1001 is being authenticated here. The physical relationship between IC card 1001 and data-writing device 1002 here will be described later.

If it is determined that the recognized ID is in the user IDs which have been stored in storage 1023, ID determining part 1024 directs data-reading part 1025 to read the contents data out from storage 1023. Data-reading part 1025 that is directed to read out the contents data reads out the contents data stored in storage 1023 at step 5.

The contents data read out by data-reading part 1025 are transmitted from laser transmitting part 1026 to IC card 1001 via a laser at step 6. Here, a laser is radiated from laser transmitting part 1026 until all the contents data to be transmitted have been transmitted. When it is determined that the low-speed light has not been received at low-speed optical receiving part 1021, laser transmission from laser transmitting part 1026 is stopped.

The laser transmitted from laser transmitting part 1026 is received by high-speed optical receiving part 1011 at step 7. The contents data carried via the received laser is written in storage 1013 by data-writing part 1012 at step 8.

Then, contents data written in storage 1013 is transmitted from external interface part 1014 to the external device to be played there.

If it is determined that the low-speed light has not been received by low-speed optical receiving part 1021 at step 3, or if it is determined that the recognized ID is not in the user IDs which have been stored in storage 1023 at step 4, processing at step 3 is repeated.

The contents data that is transmitted from data-writing device 1002 to IC card 1001 may be split into pieces of data for transmission.

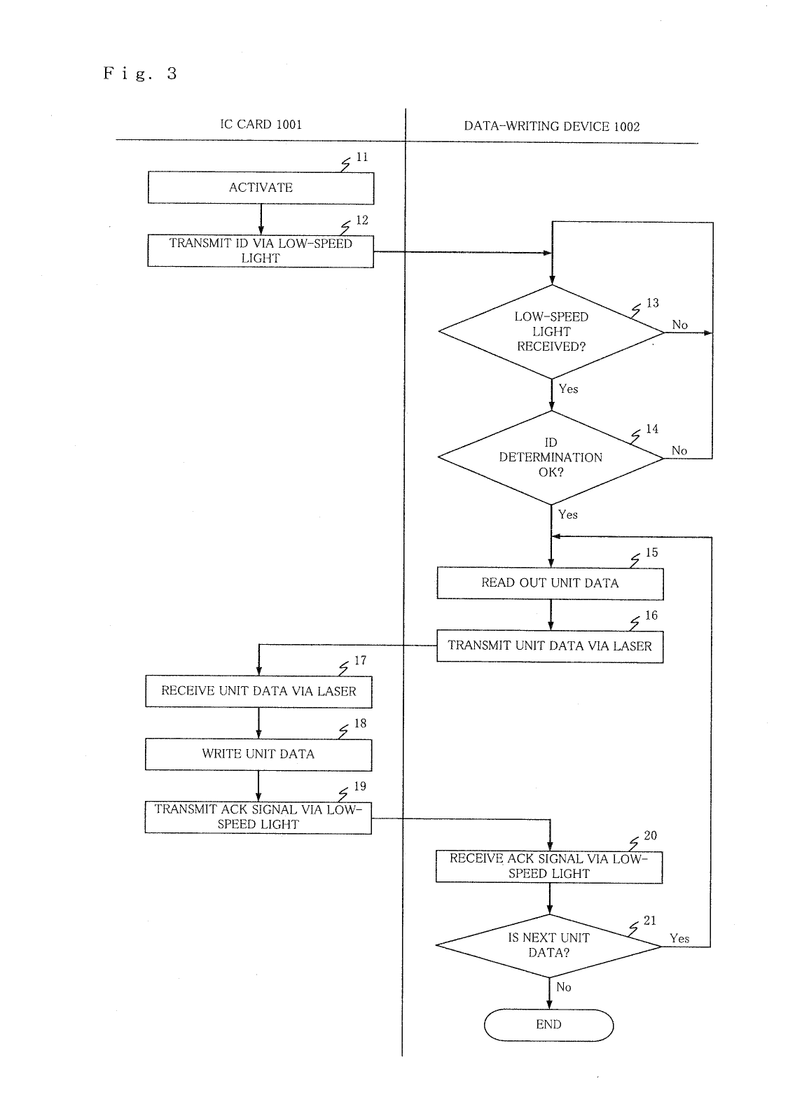

Now, another example of the optical communication method in the optical communication system shown in FIG. 1 will be described with reference to FIG. 3.

The processing at steps 11 to 14 is the same as that at steps 1 to 4, which has been described with reference to FIG. 2.

If it is determined that the recognized ID is in the user IDs which have been stored in storage 1023 at step 14, ID determining part 1024 directs data-reading part 1025 to read out the contents data. The contents data to be read out has been split into a plurality data units here, thus, ID determining part 1024 is directed to read one unit of data from among the contents data that have been split. The size of a unit data split is not particularly defined here. A sequence number is previously given to each unit data split. That sequence number is management information for assembling pieces of unit data into the original contents data after the unit data is sequentially read out and transmitted and after the transmitted unit data is received. Then, data-reading part 1025, which has been directed to read out the pieces of unit data, reads out a piece of unit data among contents data stored in storage 1023 together with the sequence number at step 15.

The unit data read out by data-reading part 1025 is transmitted from laser transmitting part 1026 to IC card 1001 with the sequence number via the laser at step 16.

When the laser transmitted from laser transmitting part 1026 is received by high-speed optical receiving part 1011 at step 17, the unit data carried via the received laser is written by data-writing part 1012 into storage 1013 at step 18.

Then, an ACK signal, which is a receipt confirmation signal for reporting that the unit data has been received, is transmitted from low-speed optical transmitting part 1016 on a low-speed light at step 19. The ACK signal contains at least a sequence number given to the unit data. That sequence number enables data-writing device 1002 that has received the ACK signal to recognize the unit data to be transmitted next.

The ACK signal transmitted from low-speed optical transmitting part 1016 via the low-speed light is received by low-speed optical receiving part 1021 at step 20. Then, data-reading part 1025 determines whether unit data with a sequence number, which is the sequence number in the received ACK signal incremented by one, is in storage 1023 at step 21. That is, whether unsent unit data is left in the contents data to be transmitted or not is determined.

If it is determined that the unit data with a sequence number, which is the sequence number in the received ACK signal incremented by one, is in storage 1023, the unit data with a sequence number, which is the sequence number in the received ACK signal incremented by one, is read out from storage 1023. Then, processing of steps 15 to 21 will be repeated until it is determined that no unit data with a sequence number, which is the sequence number in the received ACK signal incremented by one, is in storage 1023. The abovementioned processing may be performed in a manner in which the sequence number is decremented one by one. If management information is not placed in sequential order, such as numerical sequence, then management information that is to be updated based on a pre-given rule may be used.

### Second Exemplary Embodiment

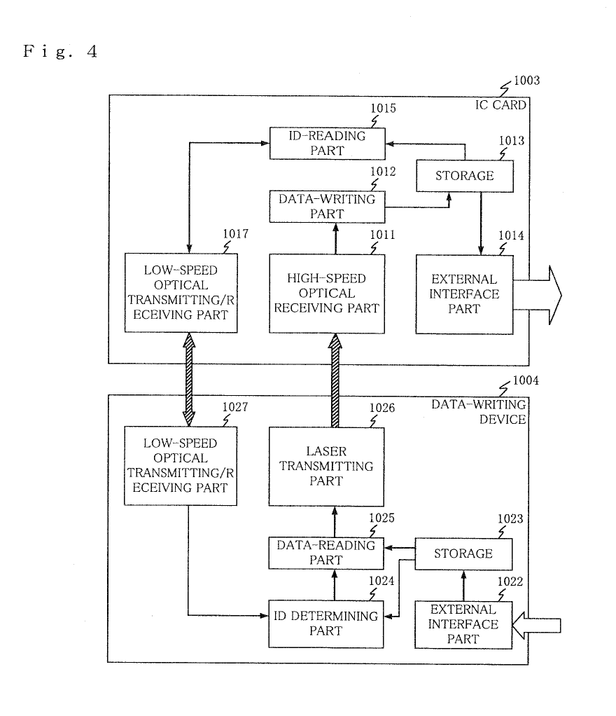

FIG. 4 shows a second exemplary embodiment of an optical communication system with IC card 1003, which is the contents receiver, and data-writing device 1004, which is the contents transmitter.

IC card 1003 is provided with low-speed optical transmitting/receiving part 1017 in the place of low-speed optical transmitting part 1016 of IC card 1001, which has been described in the first exemplary embodiment shown in FIG. 1.

Low-speed optical transmitting/receiving part 1017 is a position information transmitting part that receives the low-speed light transmitted from data-writing device 1004 and transmits the ID read out from storage 1013 by ID-reading part 1015 to data-writing device 1004 via low-speed lights.

Data-writing device 1004 is provided with low-speed optical transmitting/receiving part 1027 in the place of low-speed optical receiving part 1021 of data-writing device 1002 that has been described in the first exemplary embodiment shown in FIG. 1.

Low-speed optical transmitting/receiving part 1027 is a position information receiving part that transmits low-speed light to IC card 1003 and receives the low-speed light transmitted from low-speed optical transmitting/receiving part 1027 of IC card 1003.

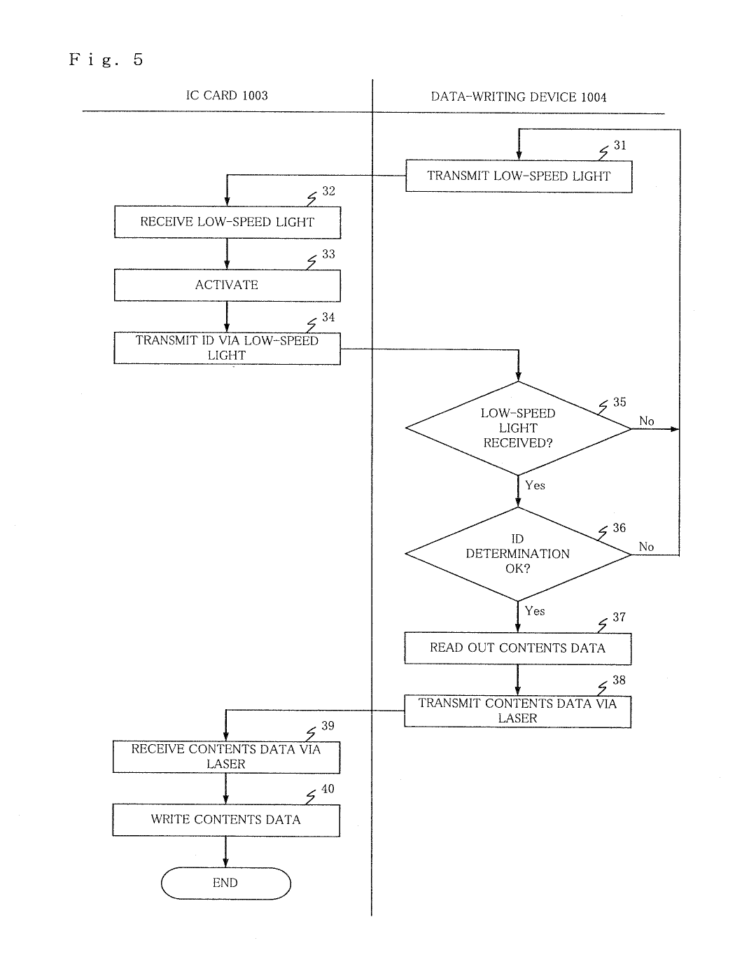

An optical communication method in the optical communication system shown in FIG. 4 will be described with reference to FIG. 5.

A low-speed light is always transmitted from low-speed optical transmitting/receiving part 1027 of data-writing device 1004 at step 31. The low-speed light that is always transmitted from low-speed optical transmitting/receiving part 1027 is less intensive than the intensity level of a pre-given threshold but is sufficient for supplying power for IC card 1003 to operate.

When IC card 1003 is held over the top of data-writing device 1004 (the structure of data-writing device 1004 will be described later), the low-speed light transmitted from low-speed optical transmitting/receiving part 1027 is received by low-speed optical transmitting/receiving part 1017 of IC card 1003 at step 32. Then, the received low-speed light activates IC card 1003 at step 33.

Here, a typical method, as shown in the first exemplary embodiment, by which IC card 1003 is activated when the radio wave for supplying power is always radiated from data-writing device 1004 to IC card 1003 and when the radio wave is received by IC card 1003, may be used, instead of the method by which the low-speed light received by low-speed optical transmitting/receiving part 1017 supplies power to IC card 1003.

Then, ID reading part 1015 reads out the ID unique to IC card 1003, which has been stored in storage 1013. The read out ID is carried via the low-speed light and transmitted from low-speed optical transmitting/receiving part 1017 to data-writing device 1003 at step 34.

Whether or not the low-speed light transmitted from low-speed optical transmitting/receiving part 1017 has been received by low-speed optical transmitting/receiving part 1027 is determined at step 35. If it is determined that the low-speed light has been received by low-speed optical transmitting/receiving part 1027, the ID carried on the received low-speed light is recognized at ID determining part 1024. Whether the recognized ID is in the user IDs which have been stored in storage 1023 or not is determined at step 36. That is, IC card 1003 is authenticated here.

If it is determined that the recognized ID is in the user IDs which have been stored in storage 1023, ID determining part 1024 directs data-reading part 1025 to read out the contents data from storage 1023. Then, data-reading part 1025 that is directed to read out the contents data reads out the contents data stored in storage 1023 at step 37.

The contents data read out by data-reading part 1025 are transmitted from laser transmitting part 1026 to IC card 1003 via a laser at step 38. Here, a laser beam is transmitted from laser transmitting part 1026 until all the contents data to be transmitted have been transmitted. When it is determined that the low-speed light has not been received by low-speed optical transmitting/receiving part 1027, laser transmission from laser transmitting part 1026 is stopped.

When the laser transmitted from laser transmitting part 1026 is received by high-speed optical receiving part 1011 at step 39, the contents data carried via the received laser is written in storage 1013 by data-writing part 1012 at step 40.

Then, the contents data written in storage 1013 is transmitted from external interface part 1014 to the external device to be played there.

If it is determined that the low-speed light has not been received by low-speed optical transmitting/receiving part 1027 at step 35, or if it is determined that the recognized ID is not in the user IDs which have been stored in storage 1023 at step 36, processing at step 31 is performed.

The contents data that is transmitted from data-writing device 1004 to the IC card 1002 may be split into pieces of data for transmission.

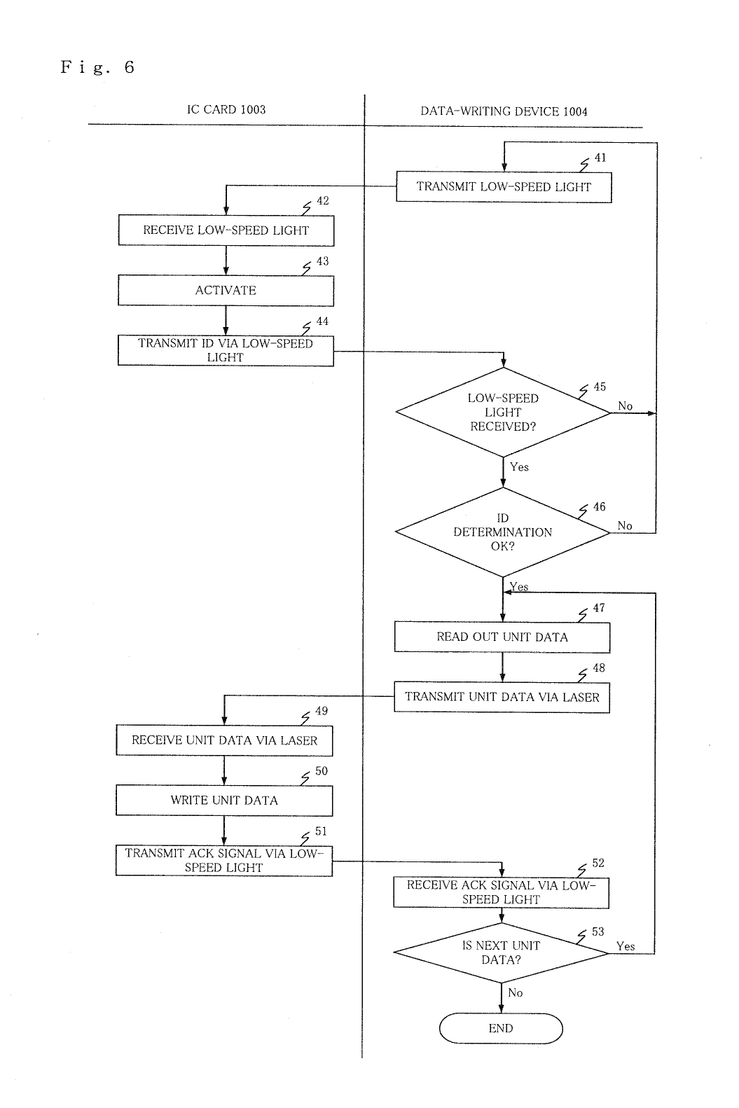

Now, another example of the optical communication method in the optical communication system shown in FIG. 4 will be described with reference to FIG. 6.

Processing at steps 41 to 46 is the same as that of steps 31 to 36, which has been described with reference to FIG. 5.

If it is determined that the recognized ID is in the user IDs which have been stored in storage 1023 at step 46, ID determining part 1024 directs data-reading part 1025 to read out the contents data. The contents data to be read out has been split into a plurality data units here, thus, ID determining part 1024 is directed to read one unit of data from among the contents data that have been split. The size of a unit data split is not particularly defined here as in the first exemplary embodiment. A sequence number, which is management information, is previously given to each unit data split. Data-reading part 1025, which has been directed to read out the pieces of unit data, reads out a piece of unit data from among contents data stored in storage 1023 together with the sequence number at step 47.

The unit data read out by data-reading part 1025 is transmitted from laser transmitting part 1026 to IC card 1003 with the sequence number via the laser at step 48.

When the laser transmitted from laser transmitting part 1026 is received by high-speed optical receiving part 1011 at step 49, the unit data carried via the received laser is written by data-writing part 1012 into storage 1013 at step 50.

Then, an ACK signal, which is a receipt confirmation signal for reporting that the unit data has been received, is transmitted from low-speed optical transmitting/receiving part 1017 via low-speed light at step 51. The ACK signal contains at least a sequence number given to the unit data. That sequence number enables data-writing device 1004 that has received the ACK signal to recognize the unit data that is to be transmitted next.

The ACK signal transmitted from low-speed optical transmitting/receiving part 1017 via the low-speed light is received by low-speed optical transmitting/receiving part 1027 at step 52. Then, data-reading part 1025 determines whether unit data with a sequence number, which is the sequence number in the received ACK signal incremented by one, is in storage 1023 or not at step 53. That is, whether unsent unit data is left in the contents data to be transmitted or not is determined.

If it is determined that the unit data with a sequence number, which is the sequence number in the received ACK signal incremented by one, is in storage 1023, the unit data with a sequence number, which is the sequence number in the received ACK signal incremented by one, is read out from storage 1023. Then, processing after step 47 is performed. Hereafter, processing at steps 47 to 53 will be repeated until it is determined that no unit data with a sequence number, which is the sequence number in the received ACK signal incremented by one, is in storage 1023. The abovementioned processing may be performed in a manner in which the sequence number is decremented one by one. If management information is not placed in sequential order, such as numerical sequence, then management information that is to be updated based on a pre-given rule may be used.

### Third Exemplary Embodiment

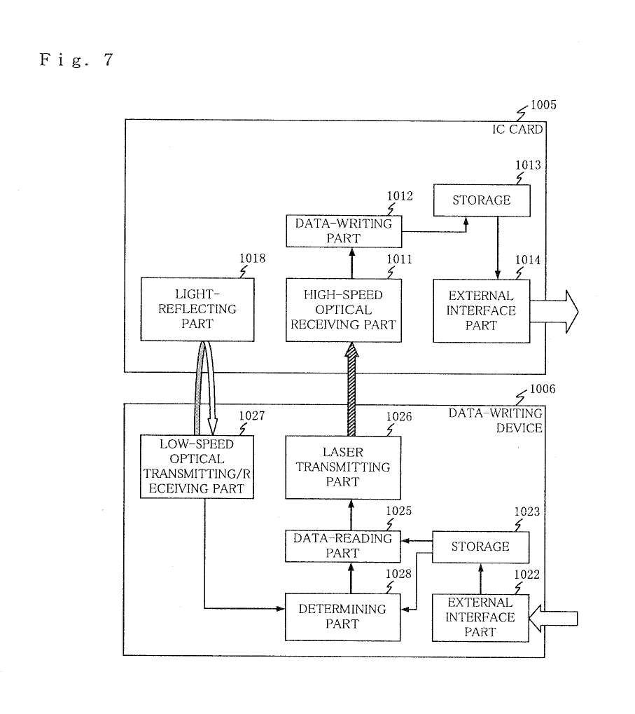

FIG. 7 shows a third exemplary embodiment of an optical communication system including IC card 1005, which is a contents receiver, and data-writing device 1006, which is a contents transmitter.

IC card 1005 includes high-speed optical receiving part 1011, data-writing part 1012, storage 1013, external interface part 1014, and light-reflecting part 1018.

High-speed optical receiving part 1011, data-writing part 1012, storage 1013, and external interface part 1014 are the same as those shown in FIG. 1. Light-reflecting part 1018 is a position information transmitting part that reflects light radiated from outside. Light-reflecting part 1018 may be a part that only reflects light at a particular preset wavelength.

Data-writing device 1006 is provided with determining part 1028 in the place of ID determining part 1024 of data-writing device 1004 that has been described in the second exemplary embodiment shown in FIG. 4.

Determining part 1028 determines whether the low-speed light transmitted from low-speed optical transmitting/receiving part 1027 to IC card 1005 and the low-speed light received by low-speed optical transmitting/receiving part 1027 are identical or not.

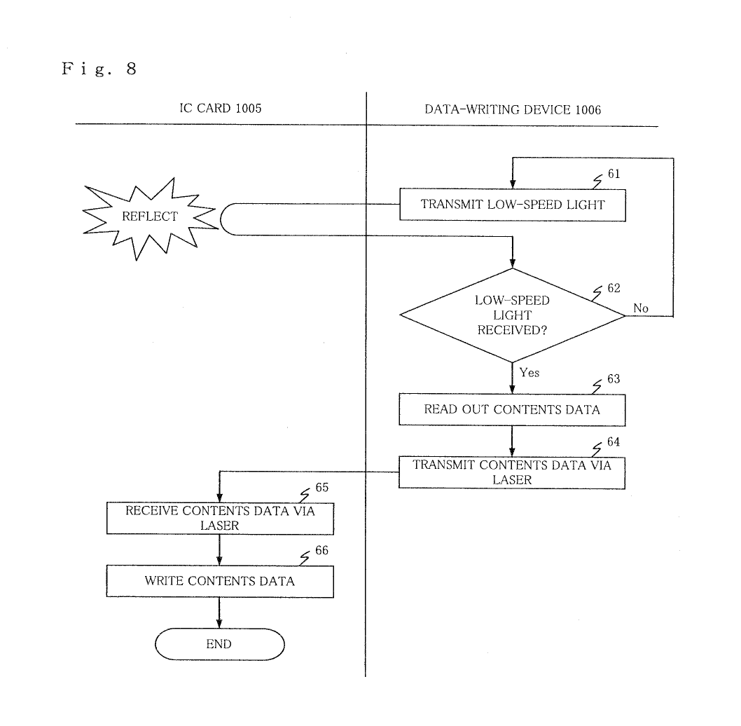

The optical communication system shown in FIG. 7 will be described with reference to FIG. 8.

A low-speed light is always transmitted from low-speed optical transmitting/receiving part 1027 of data-writing device 1006 at step 61. The low-speed light that is always transmitted from low-speed optical transmitting/receiving part 1027 is less intensive than the intensity level of a pre-given threshold. Then, the low-speed light transmitted from low-speed optical transmitting/receiving part 1027 is reflected by light-reflecting part 1018 of IC card 1005. Determining part 1028 determines whether or not the reflected low-speed light has been received by low-speed optical transmitting/receiving part 1027. That is, whether or not the low-speed light transmitted from low-speed optical transmitting/receiving part 1027 has been received by low-speed optical transmitting/receiving part 1027 is determined.

If it is determined that the low-speed light transmitted from low-speed optical transmitting/receiving part 1027 has been received by low-speed optical transmitting/receiving part 1027, determining part 1028 directs data-reading part 1025 to read the contents data out from storage 1023. Data-reading part 1025 that is directed to read out the contents data reads out the contents data stored in storage 1023 at step 63.

The contents data read out by data-reading part 1025 are transmitted from laser transmitting part 1026 to IC card 1005 via a laser at step 64. Here, laser light is transmitted from laser transmitting part 1026 until all the contents data to be transmitted have been transmitted. When it is determined that the low-speed light has not been received by low-speed optical transmitting/receiving part 1027, laser transmission from laser transmitting part 1026 is stopped.

When laser light transmitted from laser transmitting part 1026 has been received by high-speed optical receiving part 1011 at step 65, data-writing part 1012 writes the contents data carried via the received laser in storage 1013 at step 66. Here, IC card 1005 may be powered and activated in response to the laser light transmitted from laser transmitting part 1026 that is received by high-speed optical receiving part 1011.

Then, contents data written in storage 1013 is transmitted from external interface part 1014 to the external device to be played there.

If it is determined that the low-speed light transmitted from low-speed optical transmitting/receiving part 1027 has not been received by low-speed optical transmitting/receiving part 1027 at step 62, processing at step 61 is performed.

### Fourth Exemplary Embodiment

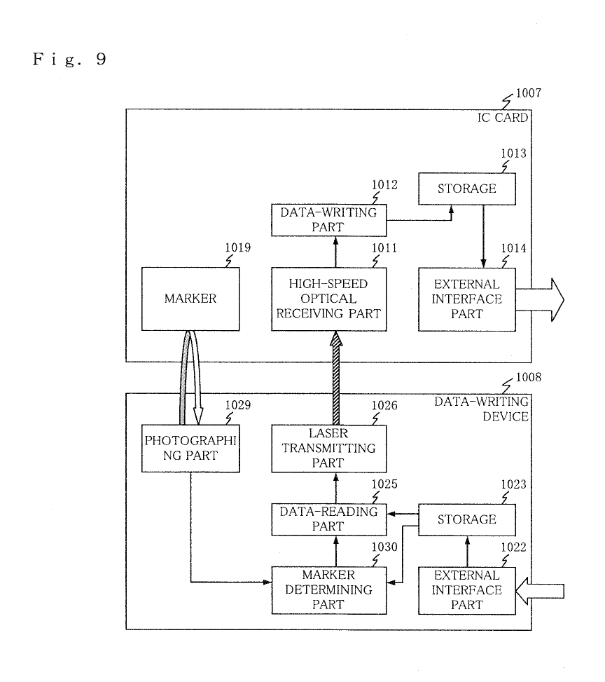

FIG. 9 shows a fourth exemplary embodiment of an optical communication system including IC card 1007, which is a contents receiver, and data-writing device 1008, which is a contents transmitter.

IC card 1007 is provided with marker 1019 in place of light-reflecting part 1018 of IC card 1005 described in the third exemplary embodiment shown in FIG. 7.

Marker 1019 is a mark printed on IC card 1007, and is a position information transmitting part that has a preset pattern unique to IC card 1007. Marker 1019 may be a heart mark or a star, for example.

Data-writing device 1008 is provided with photographing part 1029 in the place of low-speed optical transmitting/receiving part 1027 of data-writing device 1006 described in the third exemplary embodiment shown in FIG. 7.

Marker determining part 1030 is provided in the place of determining part 1028 there.

Photographing part 1029 is a position information receiving part such as a camera for photographing marker 1019 printed on IC card 1007. Marker determining part 1030 determines whether an image taken by photographing part 1029 includes marker 1019 or not.

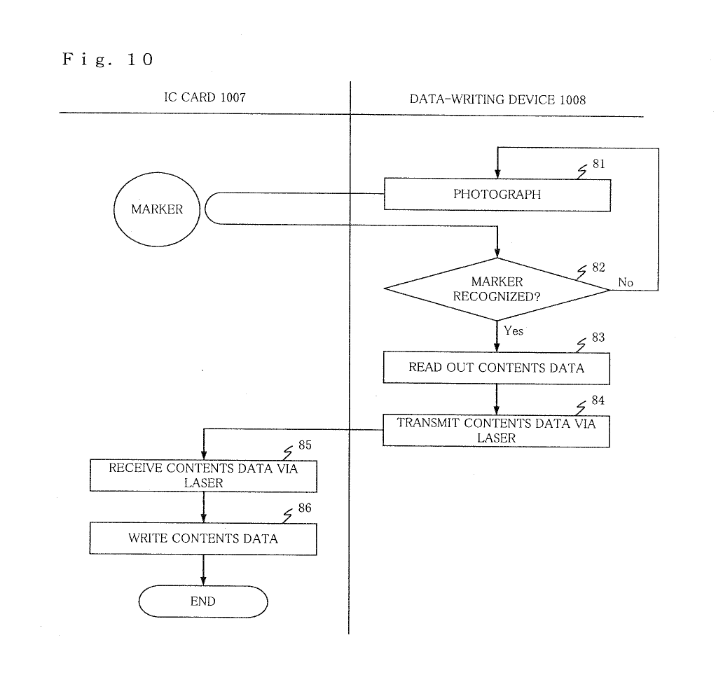

The optical communication method in the optical communication system shown in FIG. 9 will be described with reference to FIG. 10.

Photographing part 1029 of data-writing device 1008 always takes photographs at step 81. Then, marker determining part 1030 determines whether the photographed image includes marker 1019 or not at step 82. Here, as marker 1019, which has a preset pattern, marker determining part 1030, which has been stored in storage 1023, may be read out from storage 1023 and it is determined whether or not the photographed image includes marker 1019.

If it is determined that the image taken by photographing part 1029 includes marker 1019, marker determining part 1030 directs data-reading part 1025 to read the contents data out from storage 1023. Data-reading part 1025 that is directed to read out the contents data reads out the contents data stored in storage 1023 at step 83.

The contents data read out by data-reading part 1025 are transmitted from laser transmitting part 1026 to IC card 1007 via a laser at step 84. Here, laser light is transmitted from laser transmitting part 1026 until all the contents data to be transmitted have been transmitted. When it is determined that the image taken by photographing part 1029 does not include marker 1019, laser light transmission from laser transmitting part 1026 is stopped.

When laser light transmitted from laser transmitting part 1026 has been received by high-speed optical receiving part 1011 at step 85, data-writing part 1012 writes the contents data carried via the received laser in storage 1013 at step 86. Here, IC card 1007 may be powered and activated in response to the laser light transmitted from laser transmitting part 1026 that is received by high-speed optical receiving part 1011.

Then, contents data written in the storage 1013 is transmitted from external interface part 1014 to the external device to be played there.

If it is determined that the image taken by photographing part 1029 does not include marker 1019 at step 82, processing at step 81 is performed.

As mentioned above, in the present invention, a data-writing device having a position information receiving part recognizes the position of an IC card having a position information transmitting part by using a low-speed light or a set marker. Only if it has been determined that the IC card is placed at a position where a laser light can be transmitted, will the laser light that carries the contents data be transmitted from the data-writing device to the IC card.

Now, the physical relationship between IC card 1001 and data-writing device 1002 in the first exemplary embodiment and the physical relationship between IC card 1003 and data-writing device 1004 in the second exemplary embodiment and their structures will be described.

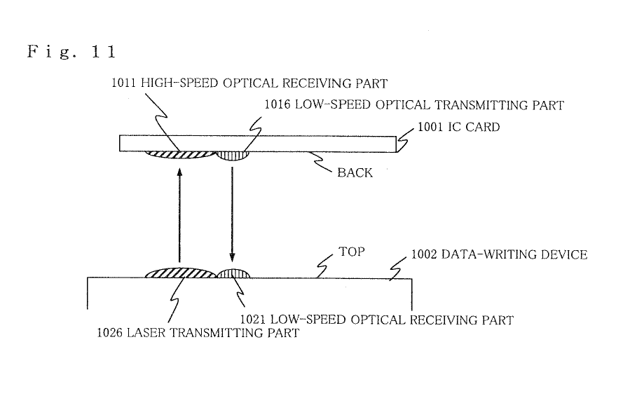

As shown in FIG. 11, high-speed optical receiving part 1011 and low-speed optical transmitting part 1016 are arranged on the back of IC card 1001. Laser transmitting part 1026 and low-speed optical receiving part 1021 are arranged on the top of data-writing device 1002. Here, the term ‘top of data-writing device 1002’ means the surface to which a user holds IC card 1001 to data-writing device 1002. The places of high-speed optical receiving part 1011 and low-speed optical transmitting part 1016 arranged on the back of IC card 1001 need to be mirror symmetrical to the places of laser transmitting part 1026 and low-speed optical receiving part 1021 arranged on the top of data-writing device 1002. When IC card 1001 is held over the top of data-writing device 1002 with the back of IC card 1001 facing the top by using the structures described above, high-speed optical receiving part 1011 receives the laser light transmitted from laser transmitting part 1026 at the place where low-speed optical receiving part 1021 receives the low-speed light transmitted from low-speed optical transmitting part 1016.

If the back of IC card 1001 tilts over the top of data-writing device 1002, problems shown below occur.

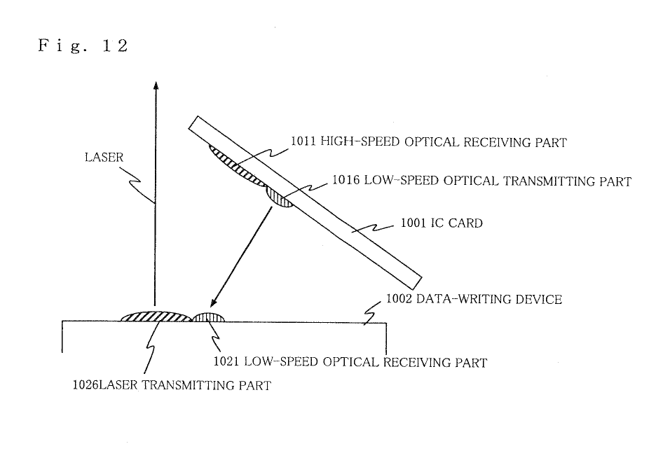

When the back of IC card 1001 tilts over the top of data-writing device 1002 as shown in FIG. 12, laser light transmitted from laser transmitting part 1026 may not be received by high-speed optical receiving part 1011 even if the low-speed light transmitted from low-speed optical transmitting part 1016 has been received by low-speed optical receiving part 1021. If the laser light transmitted from laser transmitting part 1026 not only escapes from high-speed optical receiving part 1011 but also escapes from IC card 1001, laser light transmitted from laser transmitting part 1026 will leak out.

To solve the problem, the fact that the back of IC card 1001 and the top of data-writing device 1002 are parallel needs to be detected. For the purpose of detection, low-speed optical transmitting part 1016, which is a position information transmitting part, and low-speed optical receiving part 1021, which is a position information receiving part, need to be arranged at least at three points which are not in a row on the back of IC card 1001 and the top of data-writing device 1002, i.e., which are non-linear.

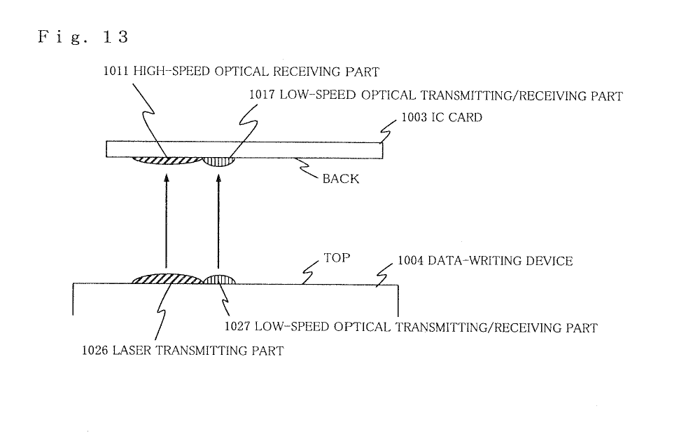

As shown in FIG. 13, high-speed optical receiving part 1011 and low-speed optical transmitting/receiving part 1017 are arranged on the back of IC card 1003. Laser transmitting part 1026 and low-speed optical transmitting/receiving part 1027 are arranged on the top of data-writing device 1004. Here, the term ‘top of data-writing device 1004’ means the surface to which a user holds IC card 1003 to data-writing device 1004. The physical relationship between high-speed optical receiving part 1011 and low-speed optical transmitting/receiving part 1017 arranged on the back of IC card 1003 needs to be plane symmetrical to that between laser transmitting part 1026 and low-speed optical transmitting/receiving part 1027 arranged on the top of data-writing device 1004. When IC card 1003 is held over the top of data-writing device 1004 with the back of IC card 1003 facing the top by using the structures described above, high-speed optical receiving part 1011 receives the laser transmitted from laser transmitting part 1026 at the place where low-speed optical transmitting/receiving part 1017 receives the low-speed light transmitted from low-speed optical transmitting/receiving part 1027.

If the back of IC card 1003 tilts over the top of data-writing device 1004, problems shown below occur.

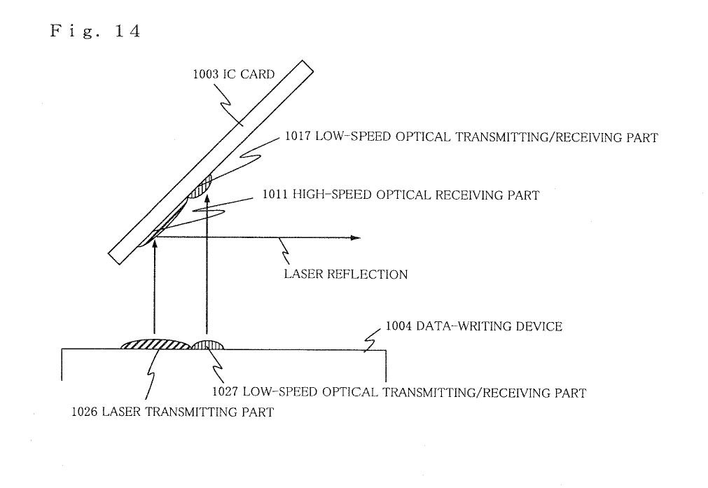

When the back of IC card 1003 tilts over the top of data-writing device 1004 as shown in FIG. 14, the laser light transmitted from laser transmitting part 1026 is received by high-speed optical receiving part 1011 at a place where the low-speed light transmitted from low-speed optical transmitting/receiving part 1027 is received by low-speed optical transmitting/receiving part 1017. At that moment, the laser light may be reflected by high-speed optical receiving part 1011 and leaked out.

To solve the problem, the fact that the back of IC card 1003 and the top of data-writing device 1004 are parallel needs to be detected. For the purpose of detection, low-speed optical transmitting/receiving part 1017, which is a position information transmitting part, and low-speed optical transmitting/receiving part 1027, which is a position information receiving part, need to be arranged at least at three points which are not in a row on the back of IC card 1003 and the top of data-writing device 1004.

The structure that satisfies the abovementioned conditions will be described below by exemplifying the arrangement of low-speed optical transmitting part 1016 and high-speed optical receiving part 1011 on the back of IC card 1001 shown in FIG. 1 as a representative case.

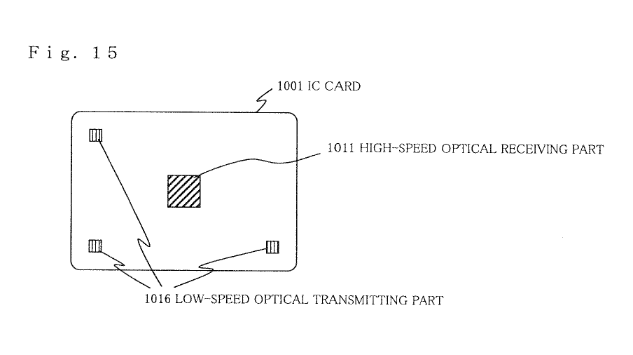

High-speed optical receiving part 1011 is arranged on the back of IC card 1001 and low-speed optical transmitting parts 1016 are arranged at three non-linear points, which are not arranged in a row as shown in FIG. 15. Low-speed optical receiving parts 1021 are arranged on the top of data-writing device 1002 at places that are plane symmetrical to those of low-speed optical transmitting parts 1016 on the back of IC card 1001, although they are not shown. As a result, only in the case where it is confirmed that the low-speed lights transmitted from three low-speed optical transmitting parts 1016 have been received by the corresponding three low-speed optical receiving parts 1021, i.e., where the place of IC card 1001 can be determined by the pre-given three points, will the laser light transmitted from laser transmitting part 1026 be received by high-speed optical receiving part 1011 without leaking out only provided that if the laser light has been transmitted from laser transmitting part 1026. The low speed light may be adapted, as the laser light is transmitted from laser transmitting part 1026 only provided that the distances between IC card 1001 and data-writing device 1002 are measured and are confirmed to be the same as the three pre-given points.

The arrangement that takes account of the abovementioned tilting of the IC card is preferably applied to the fourth exemplary embodiment, but need not be applied to the third exemplary embodiment. This is because light-reflecting part 1018 in the third exemplary embodiment shown in FIG. 7 orthogonally reflects only a light orthogonally incident thereon.

In the first to the fourth exemplary embodiments, the orientation of the IC card to be held also needs to be taken into account. That will be described by taking IC card 1001 and data-writing device 1002 in the first exemplary embodiment shown in FIG. 1 as an example.

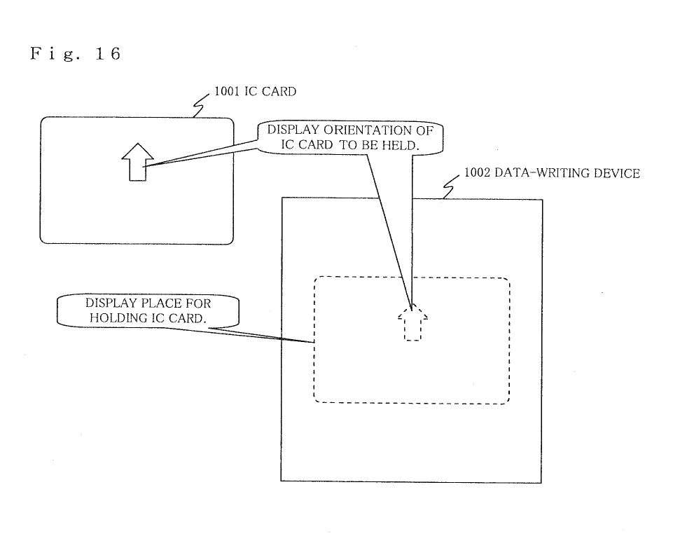

As shown in FIG. 16, the orientation of IC card 1001 that is to be held is shown on the surface of IC card 1001 and on the top of data-writing device 1002. Unless the orientation is shown like that, a user may hold IC card 1001 upside down over data-writing device 1002 in another way. In such a case, the position cannot be recognized at the three points as mentioned above.

The arrangement of low-speed optical transmitting part 1016 and high-speed optical receiving part 1011 is improved further to enable the position to be recognized by data-writing device 1002 even if IC card 1001 is held in another way.

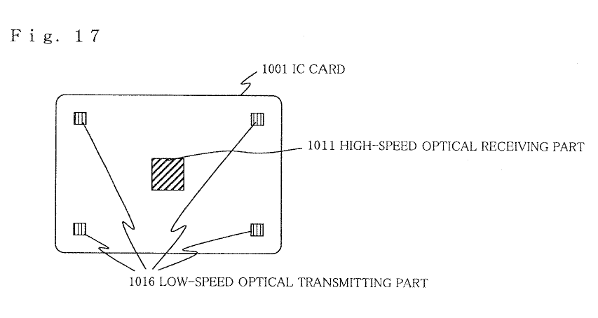

As shown in FIG. 17, low-speed optical transmitting parts 1016 are arranged at four points which are point symmetrical to each other centering on high-speed optical receiving part 1011. Low-speed optical receiving parts 1021 are arranged on the top of data-writing device 1002 at places that are plane symmetrical to those of low-speed optical transmitting parts 1016 on the back of IC card 1001, although they are not shown in the figure. That enables the position to be recognized even if IC card 1001 is held upside down over data-writing device 1002.

Now, an exemplary embodiment of the abovementioned optical communication system will be described. Here, a case where the first exemplary embodiment of the optical communication system shown in FIG. 1 will be exemplified.

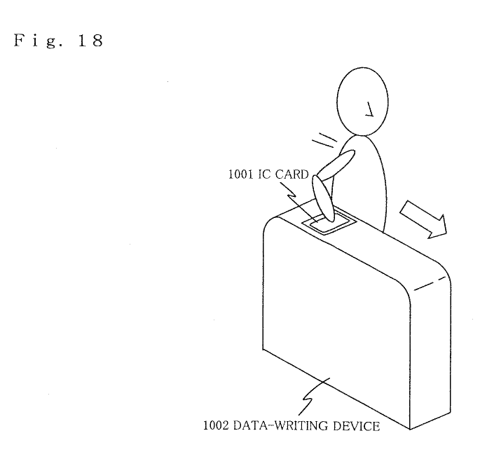

As shown in FIG. 18, the optical communication system shown in FIG. 1 is used where a user holds IC card 1001, such as Suica (Registered Trademark), a contactless IC card using the FeliCa (Registered Trademark) system, that is recently being used at ticket gates of stations, over data-writing device 1002 as the user passes by data-writing device 1002.

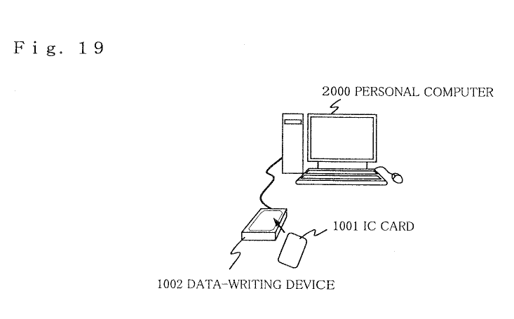

As shown in FIG. 19, the optical communication system shown in FIG. 1 is used when a user places IC card 1001 on data-writing device 1002 connected to personal computer 2000. In this case, personal computer 2000 may have components other than low-speed optical receiving part 1021 and laser transmitting part 1026 included in data-writing device 1002.

For the case where a user quickly passes by data-writing device 1002, i.e., circumstances in which the position recognition of IC card 1001 by data-writing device 1002 ends before all the contents data have been transmitted by data-writing device 1002 to IC card 1001, the exemplary embodiment shown in FIG. 18 needs to be further improved. A fifth exemplary embodiment will be described as an embodiment it that takes this into account.

### Fifth Exemplary Embodiment

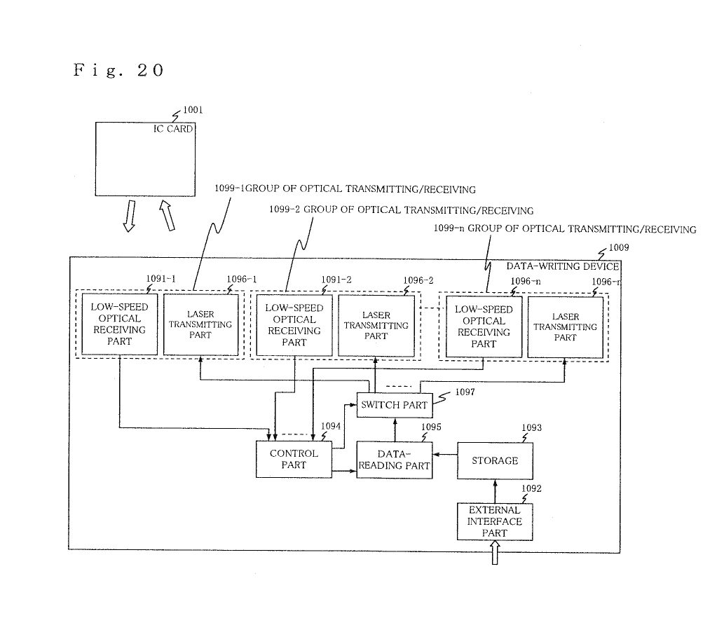

FIG. 20 shows a fifth exemplary embodiment of an optical communication system including IC card 1001 and data-writing device 1009.

IC card 1001 is the same as that described in the first exemplary embodiment shown in FIG. 1.

Data-writing device 1009 includes a plurality of low-speed optical receiving parts 1091-1 to 1091-n, external interface part 1092, storage 1093, control part 1094, data-reading part 1095, a plurality of laser transmitting parts 1096-1 to 1096-n, and switch part 1097.

Each of low-speed optical receiving parts 1091-1 to 1091-n is the same as low-speed optical receiving part 1021 shown in FIG. 1. Each of low-speed optical receiving parts 1091-1 to 1091-n has identification information such as a unique ID. External interface part 1092 is the same as external interface part 1022 shown in FIG. 1. Storage 1093 is the same as storage 1023 shown in FIG. 1. Control part 1094 determines whether or not a low-speed light has been received by any of low-speed optical receiving parts 1091-1 to 1091-n, and outputs identification information of one of low-speed optical receiving parts 1091-1 to 1091-n that is determined to have received the low-speed light to switch part 1097. Data-reading part 1095 is the same as data-reading part 1025 shown in FIG. 1. Data-reading part 1095 reads out contents data from storage 1093 and outputs the read out contents data to switch part 1097. Each of laser transmitting parts 1096-1 to 1096-n is the same as laser transmitting part 1026 shown in FIG. 1. Each of laser transmitting parts 1096-1 to 1096-n pairs up with low-speed optical receiving parts 1091-1 to 1091-n and has the same identification information as that each of low-speed optical receiving parts 1091-1 to 1091-n has. Switch part 1097 outputs the contents data, which is output from data-reading part 1095 based on the identification information output from control part 1094, to any one of laser transmitting parts 1096-1 to 1096-n. Low-speed optical receiving parts 1091-1 to 1091-n pair up with laser transmitting parts 1096-1 to 1096-n respectively to form groups of optical transmitting/receiving parts 1099-1 to 1099-n.

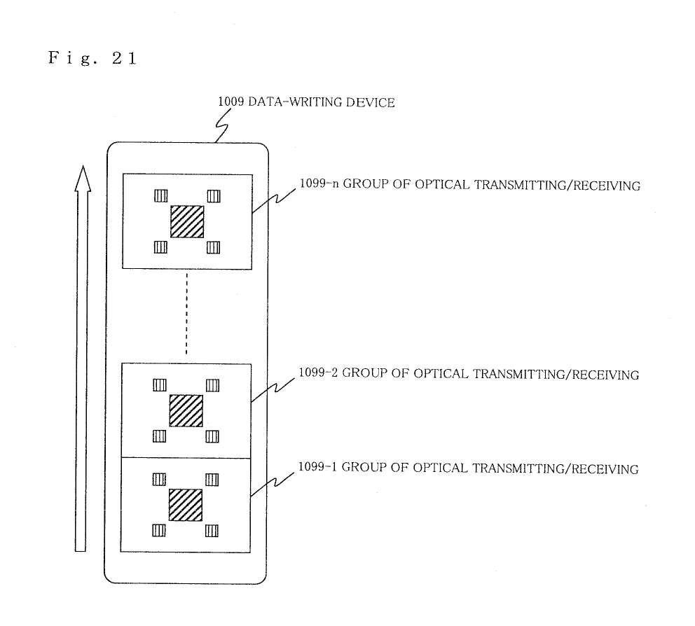

As shown in FIG. 21, the groups of optical transmitting/receiving parts 1099-1 to 1099-n are arranged in a row (arrow) on the top of data-writing device 1009 in the direction of a user passing by shown in FIG. 20. With that arrangement, the contents data is transmitted from the one part of laser transmitting parts 1096-1 to 1096-n of the plurality of groups of optical transmitting/receiving parts 1099-1 to 1099-n that has been paired up with the one part of low-speed optical receiving parts 1091-1 to 1091-n that has recognized the position of IC card 1001. Accordingly, the contents data is kept transmitted from data-writing device 1009 to IC card 10001 even if a user quickly passes by data-writing device 1009. That is, the contents data is transmitted, while IC card 1001 is being tracked.

Optical transmitting/receiving parts 1099-1 to 1099-n shown in FIG. 20 may be arranged in a plurality of rows instead of being arranged in a row as shown in FIG. 21.

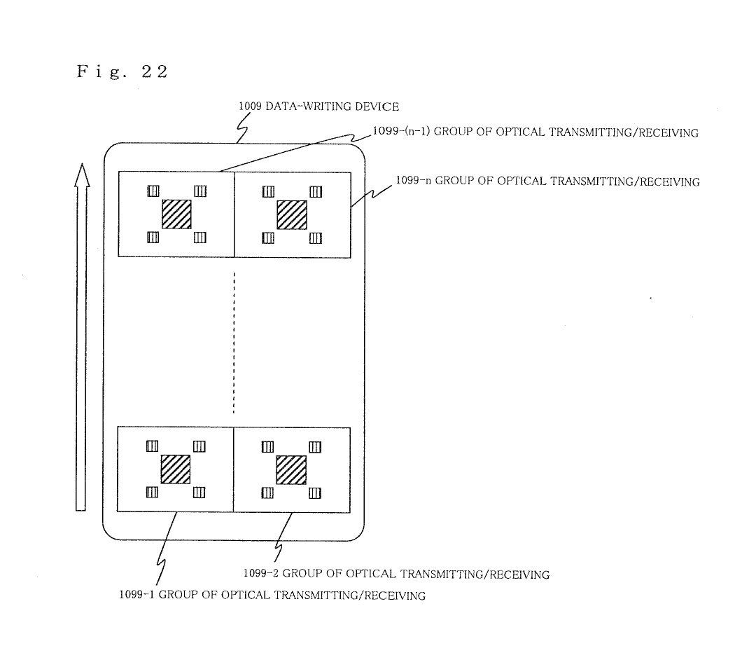

As shown in FIG. 22, optical transmitting/receiving parts 1099-1 to 1099-n are arranged on the top of data-writing device 1009 shown in FIG. 20 in two rows in the direction of a user passing by (arrow). They may be arranged in three or more rows.

In the fifth exemplary embodiment described above, in the case where low-speed optical receiving part 1091-1 has ended recognition of IC card 1001 while the contents data is being transmitted from laser transmitting part 1096-1 to IC card 1001, if only IC card 1001 is recognized by low-speed optical receiving part 1091-2, switch part 1097 switches the destination of the contents data so that the contents data that has not been transmitted is transmitted from laser transmitting part 1096-2. That can reduce the probability that transmission of contents data is aborted midway through the transmission. It is the matter of course that the fifth exemplary embodiment can be applied even in the second to fourth exemplary embodiments.

The present invention including:

a contents transmitter for transmitting contents data by using a laser and a contents receiver for receiving the contents data transmitted from the contents transmitter;

wherein said contents transmitter splits said contents data into a pre-given unit of unit data in advance, gives management information for assembling the unit data to each of the unit data, transmits the unit data with said management information that has been given, and, each time when it receives a receipt confirmation signal according to the management information given to the transmitted unit data, transmits said unit data according to the management information included in the received receipt confirmation signal in sequence; and

when said contents receiver receives said unit data, it transmits said receipt confirmation signal including the management information given to the unit data to said contents transmitter by using said light.

Said contents receiver includes:

a position information transmitting part for transmitting said identification information by using said light; and

a high-speed optical receiving part for receiving the contents data transmitted by using said laser; and

said contents transmitter includes:

a position information receiving part for receiving the identification information transmitted from said contents receiver by using said light; and

a high-speed optical transmitting part for transmitting said contents data to said contents receiver by using said laser.

Said position information receiving part always transmits a light less intensive than the intensity level of a pre-given threshold; and

when said position information transmitting part receives the light, said position information transmitting part transmits said identification information by using said light.

Said position information transmitting part and said high-speed optical receiving part are arranged on the same plane of said contents receiver, and

said position information receiving part and said high-speed optical transmitting part are arranged on the same plane of said contents transmitter,

wherein places of said position information transmitting part and said high-speed optical receiving part are mirror symmetrical to the places of said position information receiving part and said high-speed optical transmitting part.

Said position information transmitting parts are arranged on a non-linear line on the same plane of said contents receiver.

Said position information transmitting parts are arranged at places that are point symmetrical to each other centering on said high-speed optical receiving part.

Said contents receiver has a light-reflecting part for reflecting the light, and

said contents transmitter transmits a light less intensive than the intensity level of a pre-given threshold and, when a light reflected by said light-reflecting part is received, transmits said contents data to said contents receiver by using said laser.

Said contents receiver has a marker part on which a preset pattern is displayed; and

said contents transmitter has a photographing part for photographing an image, wherein, if the image taken by said photographing part includes said pattern, transmits said contents data to said contents receiver by using said laser.

Said contents receiver is in the form of a card.

A contents transmitter for transmitting contents data by using a laser, wherein

when unique identification information, which was transmitted by using a light less intensive than the intensity level of a pre-given threshold and which has been given to a contents receiver, is received from the contents receiver, and wherein when the contents receiver is for receiving the contents data, said contents transmitter transmits said contents data to said contents receiver by using a laser.

Said contents transmitter splits said contents data into pre-given units of unit data in advance, gives management information to each of the unit data in order to assemble the unit data, transmits the unit data with said management information that has been given, and each time when a receipt confirmation signal according to the management information given to the transmitted unit data is received, transmits said unit data in sequence according to the management information included in the received receipt confirmation signal.

Said contents transmitter includes:

a position information receiving part for receiving identification information that is transmitted from said contents receiver by using said light; and

a high-speed transmitting part for transmitting said contents data to said contents receiver by using said laser.

Said position information receiving part always transmits a light less intensive than the intensity level of a pre-given threshold.

Said position information receiving part and said high-speed optical transmitting part are arranged on the same plane of the contents transmitter, and

the places of said position information receiving part and said high-speed optical transmitting part are mirror symmetrical to the places of a position information transmitting part of said contents receiver for transmitting said light and to the places of a high-speed optical receiving part of said contents receiver for receiving said laser.

Said position information receiving parts are arranged on a non-linear line on the same plane of the contents transmitter.

Said position information receiving parts are arranged at places that are point symmetrical to each other centering on said high-speed optical transmitting part.

A contents transmitter transmits a light less intensive than the intensity level of a pre-given threshold and, when a reflection of the light is received, transmits the contents data to the contents receiver by using the laser.

A contents transmitter has a photographing part for photographing an image, wherein, if the image taken by said photographing part includes a preset pattern, transmits contents data to a contents receiver by using said laser.

A contents receiver for receiving a laser transmitted from a contents transmitter that transmits contents data by using the laser;

wherein said contents receiver transmits previously given unique identification information to said contents transmitter by using a light less intensive than the intensity level of a pre-given threshold.

If unit data transmitted from said contents transmitter is received, said contents receiver transmits a receipt confirmation signal including management information for assembling the unit data given to the unit data to said contents transmitter by using said light.

Said contents receiver includes:

a position information transmitting part for transmitting said identification information by using said light; and

a high-speed optical receiver for receiving contents data transmitted by using said laser.

If said position information transmitting part receives a light transmitted from said contents transmitter that is less intensive than the intensity level of a pre-given threshold, said position information transmitting part transmits said identification information by using said light.

Said position information transmitting part and said high-speed optical receiving part are arranged on the same plane of the contents receiver, and

the places of said position information transmitting part and said high-speed optical receiving part are mirror symmetrical to the places of a position information receiving part of said contents transmitter for receiving said light and to the places of a high-speed optical transmitting part of said contents transmitter for transmitting said laser.

Said position information transmitting parts are arranged in a non-linear line on the same plane of the contents receiver.

Said position information transmitting parts are arranged at places that are point symmetrical to each other centering on said high-speed optical receiving part.

Said contents receiver is in the form of a card.

A method in an optical communication system including a contents transmitter for transmitting contents data by using a laser and a contents receiver for receiving the contents data transmitted from the contents transmitter; including:

said contents receiver transmitting previously given unique identification information by using a light less intensive than the intensity level of a pre-given threshold; and

when said contents transmitter receives said identification information transmitted from said contents receiver by using said light, said contents transmitter transmitting said contents data to said contents receiver by using said laser.

The method further including:

said contents transmitter splitting said contents data into a pre-given unit of unit data in advance and giving management information to the unit data in order to assemble the unit data;

said contents transmitter transmitting the unit data with said management information that has been given; and

when said contents receiver receives said unit data, said contents receiver transmitting said receipt confirmation signal including the management information given to the unit data to said contents transmitter by using said light; and

each time said contents transmitter receives a receipt confirmation signal according to the management information given to the transmitted unit data, said contents transmitter transmitting said unit data according to the management information included in the received receipt confirmation signal in sequence.

The method further including:

said contents transmitter always transmitting a light less intensive than the intensity level of a pre-given threshold; and

when said contents receiver receives the light, said contents receiver transmitting said identification information by using said light.

A method including:

said contents transmitter transmitting a light less intensive than the intensity level of a pre-given threshold; and,

when said contents transmitter receives a light reflected by said contents receiver, said contents transmitter transmitting said contents data to said contents receiver by using said laser.

A method including:

said contents transmitter photographing an image;

said contents transmitter determining whether said photographed image includes a preset pattern or not; and

if it is determined that said photographed image includes said pattern, said contents transmitter transmitting said contents data to said contents receiver by using said laser.

While an exemplary embodiment of the present invention has been described in specific terms, such description is for illustrative purpose only, and it is to be understood that changes and variations may be made without departing from the spirit or scope of the following claims.

What is claimed is:

1. An optical communication system comprising:
a contents transmitter for transmitting contents data by using a laser and a contents receiver for receiving the contents data transmitted from said contents transmitter;
wherein said contents receiver transmits previously given unique identification information by using a light less intensive than the intensity level of a pre-given threshold; and
if said contents transmitter receives said identification information transmitted from said contents receiver by using said light, said contents transmitter transmits said contents data to said contents receiver by using said laser.

2. The optical communication system according to claim 1, wherein
said contents transmitter splits said contents data into a pre-given unit of unit data in advance, gives management information to each of the unit data in order to assemble the unit data, transmits the unit data with said management information that has been given, and, each time when it receives a receipt confirmation signal according to the management information given to the transmitted unit data, transmits said unit data according to the management information included in the received receipt confirmation signal in sequence; and
when said contents receiver receives said unit data, it transmits said receipt confirmation signal including the management information given to the unit data to said contents transmitter by using said light.

3. The optical communication system according to claim 1, wherein
said contents receiver comprises:
a position information transmitting part for transmitting said identification information by using said light; and
a high-speed optical receiving part for receiving the contents data transmitted by using said laser; and
said contents transmitter includes:
a position information receiving part for receiving the identification information transmitted from said contents receiver by using said light; and
a high-speed optical transmitting part for transmitting said contents data to said contents receiver by using said laser.

4. The optical communication system according to claim 3, wherein
said position information receiving part always transmits a light less intensive than the intensity level of a pre-given threshold; and
when said position information transmitting part receives the light, said position information transmitting part transmits said identification information by using said light.

5. The optical communication system according to claim 3, wherein
said position information transmitting part and said high-speed optical receiving part are arranged on the same plane of said contents receiver, and
said position information receiving part and said high-speed optical transmitting part are arranged on the same plane of said contents transmitter,
wherein the places of said position information transmitting part and said high-speed optical receiving part are mirror symmetrical to the places of said position information receiving part and said high-speed optical transmitting part.

6. The optical communication system according to claim 5, wherein
said position information transmitting parts are arranged in a non-linear line on the same plane of said contents receiver.

7. The optical communication system according to claim 6, wherein
said position information transmitting parts are arranged at places that are point symmetrical to each other centering on said high-speed optical receiving part.

8. An optical communication system comprising a contents transmitter for transmitting contents data by using a laser and a contents receiver for receiving the contents data transmitted from the contents transmitter; wherein
said contents receiver has a light-reflecting part for reflecting the light, and
said contents transmitter transmits a light less intensive than the intensity level of a pre-given threshold and, when a light reflected by said light-reflecting part is received, transmits said contents data to said contents receiver by using said laser.

9. An optical communication system comprising a contents transmitter for transmitting contents data by using a laser and a contents receiver for receiving the contents data transmitted from the contents transmitter; wherein
said contents receiver has a marker part on which a preset pattern is displayed; and
said contents transmitter has a photographing part for photographing an image, wherein, if the image taken by said photographing part includes said pattern, transmits said contents data to said contents receiver by using said laser.

10. The optical communication system according to claim 1, wherein said contents receiver is in the form of a card.

11. The optical communication system according to claim 8, wherein said contents receiver is in the form of a card.

12. The optical communication system according to claim 9, wherein said contents receiver is in the form of a card.

13. A contents transmitter for transmitting contents data by using a laser, wherein
when unique identification information, which was transmitted by using a light less intensive than the intensity level of a pre-given threshold and which has been given to a contents receiver, is received from the contents receiver, and wherein when the contents receiver is for receiving the contents data, said contents transmitter transmits said contents data to said contents receiver by using a laser.

14. The contents transmitter according to claim 13, wherein said contents transmitter splits said contents data into pre-given units of unit data in advance, gives management information to each of the unit data in order to assemble the unit data, transmits the unit data with said management information that has been given, and each time when a receipt confirmation signal according to the management information given to the transmitted unit data is received, transmits said unit data in sequence according to the management information included in the received receipt confirmation signal.

15. The contents transmitter according to claim 13, comprising:
a position information receiving part for receiving identification information that is transmitted from said contents receiver by using said light; and
a high-speed optical transmitting part for transmitting said contents data to said contents receiver by using said laser.

16. The contents transmitter according to claim 15, wherein
said position information receiving part always transmits a light less intensive than the intensity level of a pre-given threshold.

17. The contents transmitter according to claim 15, wherein
said position information receiving part and said high-speed optical transmitting part are arranged on the same plane of the contents transmitter, and
the places of said positional information receiving part and said high-speed optical transmitting part are mirror symmetrical to the places of a position information transmitting part of said contents receiver for transmitting said light and to the places of a high-speed optical receiving part of said contents receiver for receiving said laser.

18. The contents transmitter according to claim 17, wherein
said position information receiving parts are arranged on a non-linear line on the same plane of the contents transmitter.

19. The contents transmitter according to claim 18, wherein
said position information receiving parts are arranged at places that are point symmetrical to each other centering on said high-speed optical transmitting part.

20. A contents transmitter for transmitting a light less intensive than the intensity level of a pre-given threshold and, when a reflection of the light is received, transmitting the contents data to the contents receiver by using the laser.

21. A contents transmitter including a photographing part for photographing an image, wherein, if the image taken by said photographing part includes a preset pattern, transmitting contents data to a contents receiver by using said laser.

22. A contents receiver for transmitting previously given unique identification information to a contents transmitter, which transmits contents data by using a laser having light less intensive than the intensity level of a pre-given threshold.

23. The contents receiver according to claim 22, wherein,
if unit data transmitted from said contents transmitter is received, said contents receiver transmits a receipt confirmation signal including management information for assembling the unit data given to the unit data to said contents transmitter by using said light.

24. The contents receiver according to claim 22, comprising:
a position information transmitting part for transmitting said identification information by using said light; and
a high-speed optical receiver for receiving contents data transmitted by using said laser.

25. The contents receiver according to claim 24, wherein
if said position information transmitting part receives a light transmitted from said contents transmitter that is less intensive than the intensity level of a pre-given threshold, said position information transmitting part transmits said identification information by using said light.

26. The contents receiver according to claim 24, wherein
said position information transmitting part and said high-speed optical receiving part are arranged on the same plane of the contents receiver, and
the places of said position information transmitting part and said high-speed optical receiving part are mirror symmetrical to the places of a position information receiving part of said contents transmitter for receiving said light and to the places of a high-speed optical transmitting part of said contents transmitter for transmitting said laser.

27. The contents receiver according to claim 26, wherein
said position information transmitting parts are arranged in a non-linear line on the same plane of the contents receiver.

28. The contents receiver according to claim 27, wherein
said position information transmitting parts are arranged at places that are point symmetrical to each other centering on said high-speed optical receiving part.

29. The contents receiver according to claim 22, wherein
said contents receiver is in the form of a card.

30. A method in an optical communication system comprising a contents transmitter for transmitting contents data by using a laser and a contents receiver for receiving the contents data transmitted from the contents transmitter; comprising:
said contents receiver transmitting previously given unique identification information by using a light less intensive than the intensity level of a pre-given threshold; and
when said contents transmitter receives said identification information transmitted from said contents receiver by using said light, said contents transmitter transmitting said contents data to said contents receiver by using said laser.

31. The method according to claim 30, comprising:
said contents transmitter splitting said contents data into a pre-given unit of unit data in advance and giving management information to the unit data in order to assemble the unit data;
said contents transmitter transmitting the unit data with said management information that has been given; and
when said contents receiver receives said unit data, said contents receiver transmitting a receipt confirmation signal including the management information given to the unit data to said contents transmitter by using said light; and
each time said contents transmitter receives said receipt confirmation signal according to the management information given to the transmitted unit data, said contents transmitter transmitting said unit data according to the management information included in the received receipt confirmation signal in sequence.

32. The method according to claim 30, comprising:
said contents transmitter always transmitting a light less intensive than the intensity level of a pre-given threshold; and
when said contents receiver receives the light, said contents receiver transmitting said identification information by using said light.

33. A method in an optical communication system comprising a contents transmitter for transmitting contents data by using a laser and a contents receiver for receiving the contents data transmitted from the contents transmitter; comprising:
said contents transmitter transmitting a light less intensive than the intensity level of a pre-given threshold; and,
when said contents transmitter receives a light reflected by said contents receiver, said contents transmitter transmitting said contents data to said contents receiver by using said laser.

34. A method in an optical communication system comprising a contents transmitter for transmitting contents data by using a laser and a contents receiver for receiving the contents data transmitted from the contents transmitter; comprising:
said contents transmitter photographing an image;
said contents transmitter determining whether said photographed image includes a preset pattern or not; and
if it is determined that said photographed image includes said pattern, said contents transmitter transmitting said contents data to said contents receiver by using said laser.
